(19) United States
(12) Patent Application Publication
(10) Pub. No.: US 2009/0057246 A1
(43) Pub. Date: Mar. 5, 2009

(54) Space-saver pot lid hanging storage device

(75) Inventor: James Kraft, San Diego, CA (US)

Correspondence Address: James Kraft, 1037 Essex Street, # 9, San Diego, CA, 92103, US

(73) Assignee: Brent Kraft, West Covina, CA (US)

(21) Appl. No.: 11/897,167

(22) Filed: Aug. 30, 2007

(51) Int. Cl. A47B 81/04; A47J 47/16

(52) U.S. Cl. 211/41.11

(57) ABSTRACT

The invention is a unit that comprises of a poll or rod made out of any material such as wood, metal, heavy duty plastic, and the like. This rod can be suspended from the ceiling by chains or be secured by direct installation to the surface such as a wall or the side of a cabinet. This rod can also be installed in combination of direct surface attachment with chains suspended from the ceiling for extra support. This rod can be shortened or lengthened to fit the chosen space for hanging. Along the rod are U shaped groove that is wedged in my solid piece of rubber to prevent the pot lid holding means from sliding during usage. The second part of invention is pot lid holding means that has a hook on top in that allows the pot lid holding means to be slide directly onto the rod. On the bottom of the pot lid holding means has two hook-like extensions that curl upward in order to secure the lid. The shape of the pot lid holding means is of an upside down wishbone. The hook can vary in shapes and sizes to accommodate the many available hanging racks on the market.

### CROSS-REFERENCE TO RELATED APPLICATION

This part is not applicable.

### BACKGROUND

1. Field of the Invention

The present invention relates a pot lid space saving storage system that can be individually separated to be used with the available pot hanging storage devices on the market.

2. Description of Prior Art

The standard single residence, town house, condominium or apartment is conspicuously getting smaller. Therefore, the size of the kitchen in these of dwellings has been substantially reduced accordingly. As the modern kitchen is getting smaller, storage is a legitimate concern for all occupants, especially in the areas of pots, pans, and their respective lids.

Pot and pan lids come in various sizes, convexes, weight, and protruding handles. Therefore, it is difficult to design a pot and pan lid holder that can accommodate the various lid shapes. Some lids can be as thin as 1½ inch in total thickness, including the handle on top. Other convex lids can be as thick as 5-10 inches, including the handle on top. Some aluminum lids are relatively light, while other stainless steel and glass lids can weigh several pounds.

There are various pot lid holders or pot lid storage devices on the market, similar to those illustrated in U.S. Pat. No. 4,776,469 (1988) to Geleziunas, U.S. Pat. No. 1,527,744 (1925) to Dix, and U.S. Pat. No. 1,976,476 (1934) to Swanson. However, these devices can not universally accommodate the vast spectrum of sizes, shapes, depths, and weights of the available pot and pan lids on the market today. Freestanding pot lid holders are most likely to topple over because they cannot support the weight of the lids.

Even if the devices available on the market claim that they are universal, they appear cumbersome and complicated, such as the device in U.S. Pat. No. 5,207,334 (1993) to Lear that describes a device of having a base member and a plurality of pot lid holder modules with clasps to hold a pot lid in a scissor-like hold. For a general manufacturer or consumer, the invention appears rather complicated with too many intricate parts. Further, this device will require a significant amount of shelf or counter space.

Therefore, most households do not purchase pot and pan lid holders or storage system due to their shortcomings. The result of that is a cupboard full of lids that can not be stacked on top of each other due to the handles on top of the lids.

### ADVANTAGES OF THE INVENTION

The object of the present invention is to provide a pot and pan lid holder space saver system which is universal in its use that ensures a very sturdy and secured support of pan and pot lids for the modern dwellings. The invention can be manufactured cheaply and feasibly. Further, it can be installed quickly and any kitchen, regardless of the size of the available space. The invention can also be used in conjunction with other already available kitchen hanging devices. This invention can support all types, sizes, shapes and weights of pot and pan lids. Additionally, this invention can be ornamental and stylish in any kitchen.

### SUMMARY OF INVENTION

The invention comprises of a poll or rod made out of any material such as wood, metal, heavy duty plastic, and the like. This rod can be suspended from the ceiling by chains or be secured by direct installation to the surface such as a wall or the side of a cabinet. This rod can also be installed in combination of direct surface attachment with chains suspended from the ceiling for extra support. This rod can be shortened or lengthened to fit the chosen space for hanging. Along the rod are U shaped groove that is wedged in my solid piece of rubber to prevent the hooks from sliding during usage.

The second part of invention is pot lid holding means that has a hook on top in that allows the pot lid holding means to be slide directly onto the rod. On the bottom of the pot lid holding means has two hook-like extensions that curl upward in order to secure the lid. The shape of the pot lid holding means is of an upside down wishbone. The hook can vary in shapes and sizes to accommodate the many available hanging racks on the market.

### DRAWING FIGURES

FIG. 1: View of invention in use in a kitchen space.

FIG. 2: Front view of different embodiments of pot lid holding means.

FIG. 3: Side view of hanging rod.

FIG. 4: Side view of bottom extension with curlicue tip.

FIG. 5: Front view of hanging rod with U groove and rubber stopper.

### REFERENCE NUMERALS IN DRAWINGS

1. rod
2. chain
3. sockets
4. attachment surface
5. ceiling
6. U groove
7. lid
10. holding means
11. hook
12. bottom extension
13. plastic tip
14. rubber stopper

### DESCRIPTION OF THE PREFERRED EMBODIMENTS

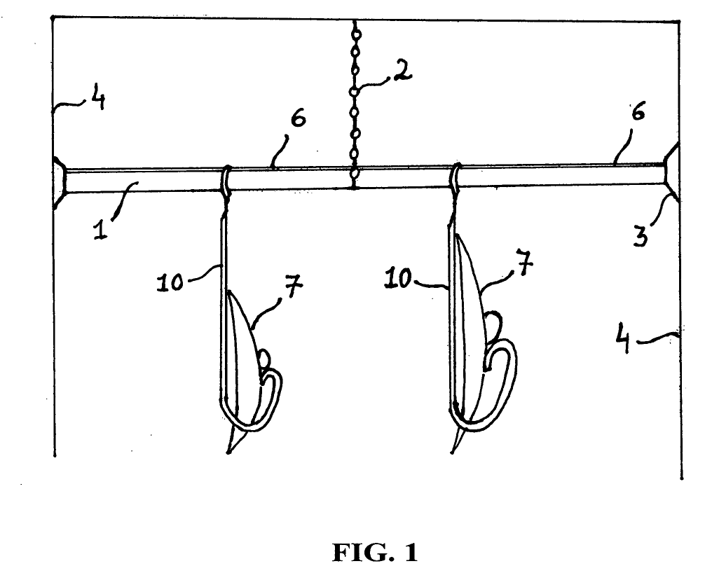

This is a space saver pot lid hanging storage system that can accommodate all different shapes, sizes, depths and weights of pot and pan lids. The system comprises of a hanging rod 1 that can be suspended in the air. Hanging from the rod 1 are pot lid holding means 10 that have hooks 11 on top to be hooked to the rod. The system makes use of available ceiling space and free up countertop and cabinet space. The pot lid holding means 10 faces sideway in order to maximize storage space, as illustrated in FIG. 1. The pot lid holding means 10 can be spaced by user according to the needs because of the presence of the U groove 6 with rubber stopper 14 wedged in U groove 6 on top of rod 1.

Rod 1 can be made of wood, metal, and other sturdy plastic materials. Wood rods can be cut down to size to fit in the desired space. Metal and plastic rods 1 can be expanded to fit the desired space. Rod 1 can attach to any surface 4, the wall or the side of the kitchen cabinet, with sockets 4, a manner commonly used to attach polls and rods by most people. With longer rods 1, ceiling chains 2 may be needed to give additional support to the rod 1. The rod 1 may be anywhere from ½ inch to 2 inches in diameter, depending on the material, size or style desired by manufacturer, so long as it can support the various weights of pod lids 7.

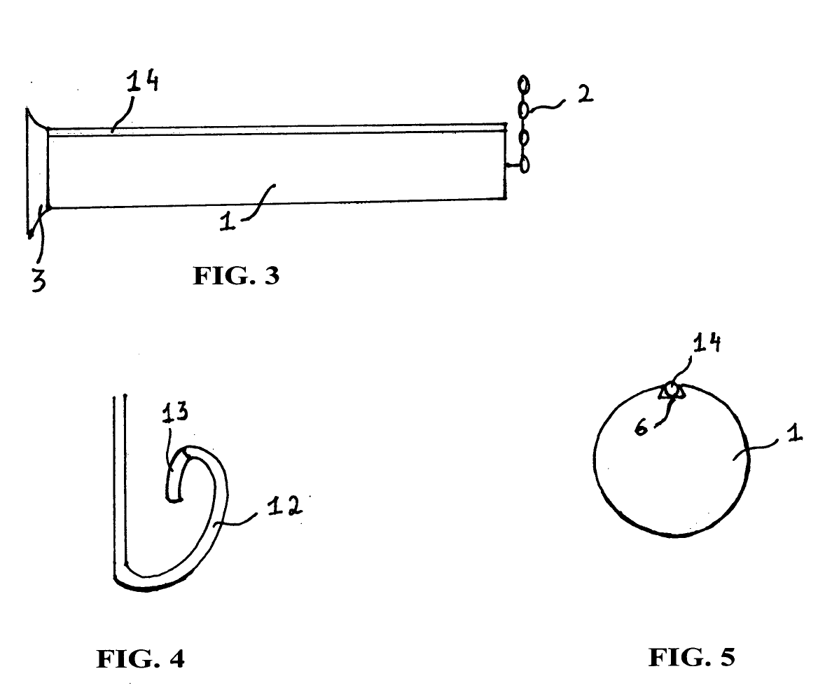

Rod 1 has U-shaped groove 6 along its entire length. The groove 6 is continuous along the upper part of rod 1. Wedged in the middle of groove 6 is a continuous piece of rubber stopper 14 to prevent the pot lid holding means 10 from sliding during usage, as illustrated in FIGS. 3 and 5.

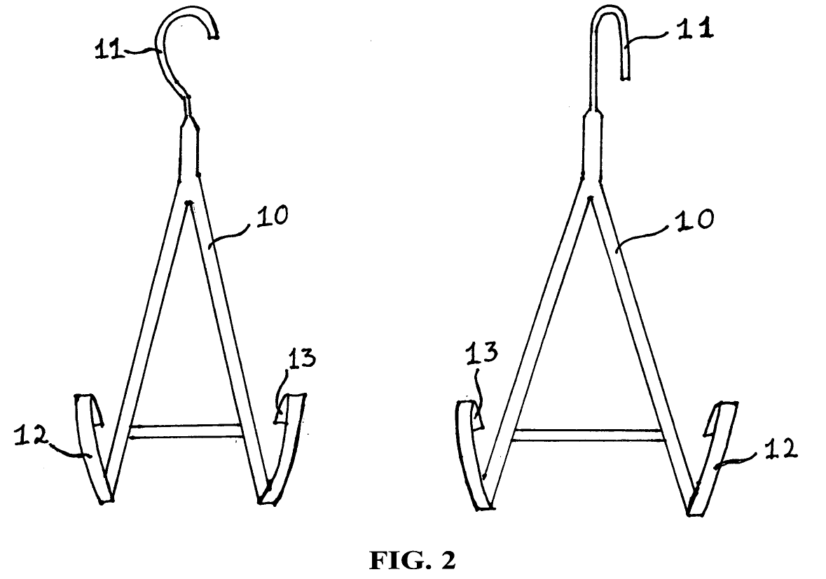

The pot lid holding means 10 can be made out of wood, metal, or sturdy plastic. It looks like an upside down wishbone, as illustrated in FIG. 2. The thickness of the pot lid holding means 10 can be anywhere between 3-25 mm, depending on the style desired and/or material used. The pot lid holding means 10 can be of a flat or circular shape, depending on the style desired. The pot lid holding means 10 will be facing attachment surface 4 in order to make efficient use of space, as illustrated in FIG. 1.

The pot lid holding means 10 total height can range anywhere between 16-20 inches, depending on the desired style of the manufacturer. On the top of the pot lid holding means 10 is a hook 11 that can hook itself around rod 1 to hang, as illustrated in FIG. 1. The hook 11 can be slid along the rod 11 to accommodate the user's needs. The hook 11 can be either round or inverted U-shaped, as illustrated in FIG. 2. The inverted U-shaped hooks 11 can be used to accommodate various available hanging racks on the market that have an opening for U-shaped hooks 11.

The bottom of the pot lid holding means 10 has two upward curl extensions 12. These extensions 12 are used to secure the lid 7. The curlicue tip 13 of extension 12 has a rubber or plastic coating to prevent scratching of lid 7. The bottom extension 12 can rise upward from 1½-7 inches depending on the size of the lid 7. The curlicue tip 13 can be 2-7 inches away from the back of holding means 10. The width between the two bottom extensions 12 can range from 5-10 inches, depending on the size of the lid 7, as illustrated in FIG. 4.

I claim:

1. A pot lid holder unit, comprising of:
a. a hanging rod
b. pot lid holding means
whereby, the pot lid holder can be hung between various spaces in the kitchen and universally accommodate all pot an pan lids.

2. A pot lid holder unit in claim 1 where said hanging rod has a U-groove with a rubber stopper that can be adjusted to fit in most kitchen space that is made of wood, metal, plastic, and other sturdy materials, and whereby the rod can be attached directly to a surface or hung from the ceiling by chains or in a combination of both.

3. A pot lid holder unit in claim 1 wherein said pot lid holding means is comprised of:
a. a hooking means on the top
b. an inverted wishbone body
c. two bottom extending means that curl upwards

4. A pot lid holder unit in claim 1 wherein said hooking means can be of various shapes and can be adapted to available kitchen hanging devices on the market.

5. A pot lid holder unit in claim 1 wherein said bottom extending means has a curlicue tip that is coated in rubber to prevent scratching of the pot lid.
